(19) United States
(12) Patent Application Publication
(10) Pub. No.: US 2025/0206030 A1
(43) Pub. Date: Jun. 26, 2025

(54) INK DELIVERY SYSTEM

(71) Applicant: Ricoh Company. Ltd, Tokyo (JP)

(72) Inventors: Calum COUTTS, Shropshire (GB); Derek SMITH, Shropshire (GB); Oliver HARRISON, Shropshire (GB)

(73) Assignee: Ricoh Company, Ltd., Tokyo (JP)

(21) Appl. No.: 18/848,964

(22) PCT Filed: Mar. 29, 2023
(86) PCT No.: PCT/JP2023/012854

§ 371 Date: Sep. 20, 2024

(30) Foreign Application Priority Data
Apr. 1, 2022 (GB) 2204762.5

(51) Int. Cl. B41J 2/175; B33Y 80/00; B41J 2/18; B41J 29/377

(52) U.S. Cl. CPC B41J 2/17596; B41J 2/17563; B41J 2/18; B41J 29/377; B33Y 80/00

(57) ABSTRACT

The disclosure concerns an ink delivery system for supplying ink to a print head. The ink delivery system comprises a sump tank, a header tank, an ink flow channel between the sump tank and the header tank, and a pump configured to pump ink from the sump tank, through the ink flow channel, to the header tank. The ink delivery system further comprises an outer casing and a heater. The outer casing houses the sump tank, the header tank and the ink flow channel. The outer casing comprises an outer wall configured to transmit heat from the heater to ink in the ink flow channel.

### TECHNICAL FIELD

The present invention relates to an ink delivery system suitable for use in a printing system, and a method for manufacturing the ink delivery system.

### BACKGROUND ART

In printing systems, such as an ink jet printer, the print head is configured to deposit ink onto a substrate. The purpose of the ink delivery system is to supply ink to one or more print heads. For optimum print quality, the ink is preferably supplied at a certain target ink temperature and pressure. If the temperature of ink supplied to the print head deviates to far from the target ink temperature, this can create issues in the print quality.

In recirculating ink system such as disclosed in U.S. Pat. No. 8,444,259 B2, ink from the recirculating ink system flows to and from the print head, recirculates around the ink system and flows back to the print head. With systems such as this, as ink is deposited onto the substrate, the amount of ink circulating in the system may be reduced. When the amount of ink in the recirculating ink delivery system drops below a certain threshold, new ink can be supplied to the recirculating system from a bulk ink delivery system.

In existing printing systems, the ink is supplied from the bulk ink delivery system to the ink delivery system via an in-line heater, such that the new ink enters the ink delivery system at a temperature close to the target ink temperature. This requires the new ink to be quickly heated from ambient room temperature to the target ink temperature, which can require a high power heater.

### CITATION LIST

### Patent Literature

[PTL 1] U.S. Pat. No. 8,444,259 B2

### SUMMARY OF INVENTION

### Technical Problem

The present invention aims to provide means to effectively maintain the temperature of ink circulating through the ink delivery system. The system aims to enable efficient use of a single heater to both heat new incoming ink being supplied to the ink delivery system and to maintain the temperature of ink circulating through the ink delivery system. The ink delivery system may therefore make an efficient use of fewer components. This could contribute to sustainability of the system by reducing material and energy consumption and cost associated with manufacture, operation and maintenance of the system. Furthermore, the ink delivery system of the present invention aims to be compact, while allowing easy access to those parts most likely to require maintenance. The present invention also aims to provide a cost effective method to manufacture the ink delivery system without increasing build time.

### Solution to Problem

In accordance with the present invention, an ink delivery system, for supplying ink to a print head, comprises a sump tank configured to contain ink and having an incoming ink inlet configured to receive ink from a bulk ink delivery system, a sump inlet configured to receive ink from a print head, and a sump outlet configured to supply ink to a header tank. The header tank is configured to contain ink and having a header inlet configured to receive ink from the sump tank and a header outlet configured to supply ink to the print head. The ink delivery system further comprises an ink flow channel between the sump tank and the header tank. The ink delivery system further comprises a pump configured to pump ink from the sump tank, through the ink flow channel, to the header tank. The ink delivery system further comprises an outer casing housing the sump tank, the header tank and the ink flow channel. The outer casing comprises an outer wall configured to transmit heat to ink in the ink flow channel. The ink delivery system further comprises a heater configured to heat the outer wall of the outer casing.

Optionally, the outer wall comprises an inner surface defining a surface of the inkflow channel. Optionally the outer wall comprises an outer surface, on the exterior of the outer casing. The heater may be configured to heat the outer surface of the outer wall.

Optionally, the ink flow channel is configured such that ink in the ink flow channel contacts the inner surface of the outer wall of the outer casing.

Optionally, the ink flow channel is configured to guide ink along an ink flow path between the sump outlet and the header inlet; wherein the ink flow path follows an indirect route from the sump outlet to the header inlet. Optionally, wherein the ink flow path is a helix or a meander.

Optionally, the ink delivery system further comprising an inner casing disposed within the outer casing, and comprising an outer surface on an the exterior of the inner casing; and one or more ridges between the inner casing and the outer casing. The ink flow channel may be defined by the inner surface of the outer casing, the outer surface of the inner casing, and the one or more ridges.

Optionally, the sump tank and the header tank are housed within the inner casing.

Optionally, the inner casing forms the sump tank and the header tank.

Optionally, the shape of the one or more ridges defines the route of the ink flow path between the inner casing and the outer casing from the sump outlet to the header inlet.

Optionally, the heater is configured to heat the ink in the ink flow channel such that the ink enters the header tank at a target ink temperature between 45° C. and 55° C.

Optionally, the heater is disposed to contact the outer casing in an area extending between the sump outlet and the header inlet in a longitudinal direction of the outer casing.

Optionally, the heater is an electric heater.

Optionally, the sump tank is disposed at an opposite end of the outer casing than the header tank in a longitudinal direction of the outer casing.

Optionally, the outer casing has a cylindrical shape, and the ink delivery system is configured such that the header tank is higher than the sump during use.

Optionally, the ink delivery system further comprises a return tank configured to contain ink and having a return inlet configured to receive ink from the print head, a return overflow inlet configured to receive ink from the header tank and a return overflow outlet configured such that ink exceeding a predetermined threshold level in the return tank flows to the sump tank. The header tank may comprise a header overflow outlet configured such that ink exceeding a predetermined threshold level in the header tank flows to the return tank. The ink delivery system may be configured such that the return tank is lower than the header tank and higher than the sump during use.

Optionally, the ink delivery system comprises an opening providing a vent from the header tank to atmosphere.

Optionally, the ink delivery system further comprises an ink filter disposed within the outer casing and configured to filter ink flowing through the ink flow channel.

Optionally, the ink delivery system further comprises a control system configured to set a target temperature of the heater based on information of ink supply from the bulk ink delivery system to the sump.

In accordance with the present invention, a printing system comprises the ink delivery system, a bulk ink delivery system configured to supply ink to the sump tank via the incoming ink inlet; and a print head. The ink delivery system is configured to supply ink to the print head.

In accordance with the present invention, a method of manufacturing the ink delivery system comprises a step of additive manufacturing.

### BRIEF DESCRIPTION OF DRAWINGS

The present invention will now be described with reference to exemplary embodiments and the accompanying figures, in which:

FIG. 1 is a schematic diagram of a printing system including an ink delivery system.

FIG. 2A is a schematic diagram of an ink delivery system according to an embodiment of the present invention, showing an outer casing as viewed from the front.

FIG. 2B is a cross-sectional view through section A-A of the drum of FIG. 2A.

FIG. 3A is a schematic diagram of the ink delivery system of FIG. 2A, further including a heater provided around the outer casing, viewed from the side.

FIG. 3B is a cross-sectional view through section B-B of the drum of FIG. 3A.

FIG. 4 is a schematic diagram of an interior of the ink delivery system of FIG. 2A, showing an inner casing and ridge.

FIG. 5A is a schematic diagrams of the interior of the ink delivery system according to embodiments of the present invention, showing the inner casing and ridge(s).

FIG. 5B is a schematic diagrams of the interior of the ink delivery system according to embodiments of the present invention, showing the inner casing and ridge(s).

FIG. 6 is a schematic diagram of a first end cap of the ink delivery system according to an embodiment of the present invention.

FIG. 7 is a schematic diagram of a second end cap of the ink delivery system according to an embodiment of the present invention.

FIG. 8 is a schematic diagram of a printing system including an ink delivery system including a return tank.

FIGS. 9A is a schematic diagrams of ink delivery systems each including a header tank comprising a plurality of chambers and a return tank comprising a plurality of chambers.

FIG. 9B is a schematic diagrams of ink delivery systems each including a header tank comprising a plurality of chambers and a return tank comprising a plurality of chambers.

FIG. 10 is a schematic diagram of a printing system including print heads and recording medium and ink delivery system according to an embodiment of the present invention.

### DESCRIPTION OF EMBODIMENTS

### Printing System Overview

Printing systems are used to form printed images on a substrate, such as paper. A printing system comprises an ink delivery system to supply ink to one or more print heads which deposit some of the ink on the substrate to form the printed image. The ink delivery system is preferably a self-contained unit which can be removably attached to the printing system. The ink delivery system may be removed from the printing system, for example for maintenance or replacement by a different ink delivery system.

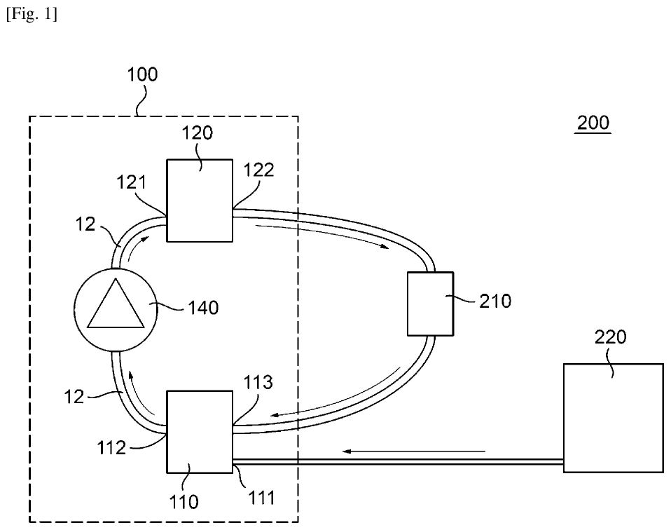

An example of a printing system 200 is shown in FIG. 1. The printing system 200 comprises an ink delivery system 100, a print head 210 and a bulk ink delivery system 220. The ink delivery system is configured such that ink flows in the direction indicated by the arrows in FIG. 1. The ink delivery system is configured to receive new ink from the bulk ink delivery system 220 and to supply ink to the print head 210. The print head 210 is configured to deposit ink, for example to print an image on a substrate. The ink delivery system is configured such that ink which is supplied to the print head 210, but not deposited for printing, continues to be circulated through the ink delivery system.

Although only one print head 210 is shown in FIG. 1, the printing system may comprise a plurality of print heads. Preferably, the printing system comprises at least four print heads. The printing system may comprise a plurality of ink delivery systems. Each ink delivery system of the printing system may be configured to supply ink to a single corresponding print head. In this way, each print head can be dedicated to printing a particular colour of ink and that colour of ink can be provided to the corresponding ink delivery system. The printing system may have multiple print heads for each colour, e.g. to enable high speed printing, in which case each ink delivery system may supply multiple print heads. The printing system may be capable of printing more than four colours, e.g. 5 or 6. In this case the printing system can print special colours, e.g. white or metallic colours, in addition to CMYK.

As shown in FIG. 1, the ink delivery system 100 comprises a sump tank 110 and a header tank 120. The sump tank 110 and the header tank 120 are each configured to contain ink. The sump tank 110 has an incoming ink inlet 111 configured to receive ink from the bulk ink delivery system 220. The sump tank 110 also has a sump inlet 113 configured to receive ink from the print head 210. The sump tank 110 also has a sump outlet 112 configured to supply ink to the header tank 120. The header tank 120 has a header inlet 121 configured to receive ink from the sump tank 110 and a header outlet 122 configured to supply ink to the print head 210.

The ink delivery system 100 of FIG. 1 further comprises an ink flow channel 12 between the sump tank 110 and the header tank 120. The ink flow channel 12 is configured to facilitate fluid communication between the sump tank 110 and the header tank 120. In particular, the ink flow channel 12 is preferably configured to contain and direct ink being pumped from the sump outlet 112 to the header inlet 121. The ink delivery system comprises a pump 140 configured to pump ink from the sump tank 110, through the ink flow channel 12, to the header tank 120.

The ink is preferably supplied to the ink head 210 at a target ink temperature. The target ink temperature may be in the range of between 40° C. and 60° C., more preferably between 45° C. and 55° C., yet more preferably between 48° C. and 52° C. The acceptable deviation from the target temperature may be +5° C., preferably +2° C., more preferably ±1.5° C., yet more preferably ±1° C. If the ink is supplied at a temperature deviating beyond an acceptable margin from the target ink temperature, the print quality may be reduced. It is preferable that ink in the header tank 120 is maintained at the target ink temperature. In this way, ink supplied to the ink head 210 from the header tank 120 may not require significant heating or cooling in order to have an acceptable temperature through the print head. The ink delivery system is preferably configured to maintain ink in the header tank at the target ink temperature, particularly during printing. The print head 210 may be provided with a heater to maintain the ink at the target ink temperature.

The heater and the arrangement of the ink flow channel enable efficient heat transfer to ink in the ink delivery system. The new ink supplied from the bulk ink delivery system and the ink already circulating in the ink delivery system are both provided to the sump and pumped through the ink flow channel to the header tank. The heater therefore heats both the new, colder, ink and the previously circulated ink as the ink travels through the ink flow channel. With this arrangement, the ink may be readily maintained at a temperature within an acceptable deviation of target temperature.

The bulk ink delivery system 220 is configured to supply ink to the sump tank 110 via the incoming ink inlet 111. The bulk ink delivery system may contain ink at ambient room temperature. The temperature of the ink supplied to the sump tank 110 from the bulk ink delivery system 220 may be at ambient room temperature. For example, the ink supplied to the sump tank 110 from the bulk ink delivery system 220 may be below 30° C., possibly below 20° C.

The ink delivery system 100 is configured to heat ink in the ink delivery system 100 such that ink in the header tank 120 is at the target ink temperature. Overheating of the ink can cause damage to the ink which may result in poor print quality even if the ink is cooled to the target ink temperature before being deposited from the print head 210. Consequently, the ink delivery system 100 is preferably configured such that ink in the ink delivery system does not exceed a predetermined maximum ink temperature. The predetermined maximum ink temperature being, for example, 60° C., preferably 55° C.

### Ink Delivery System

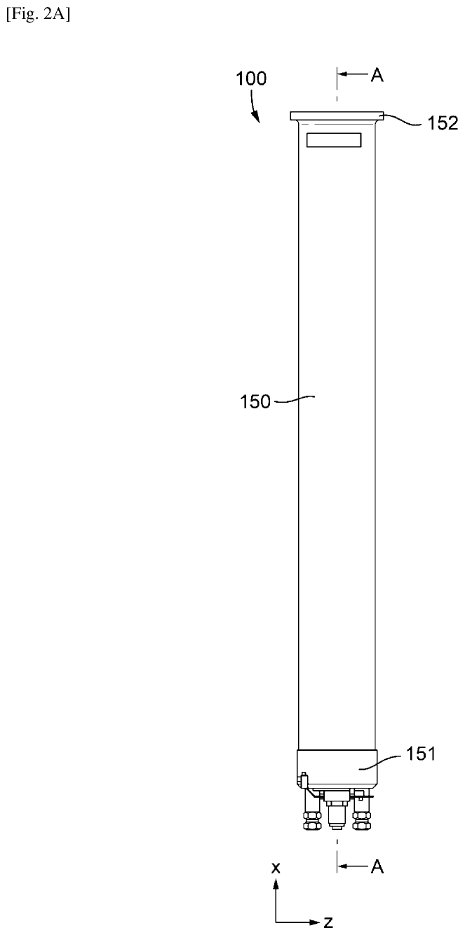

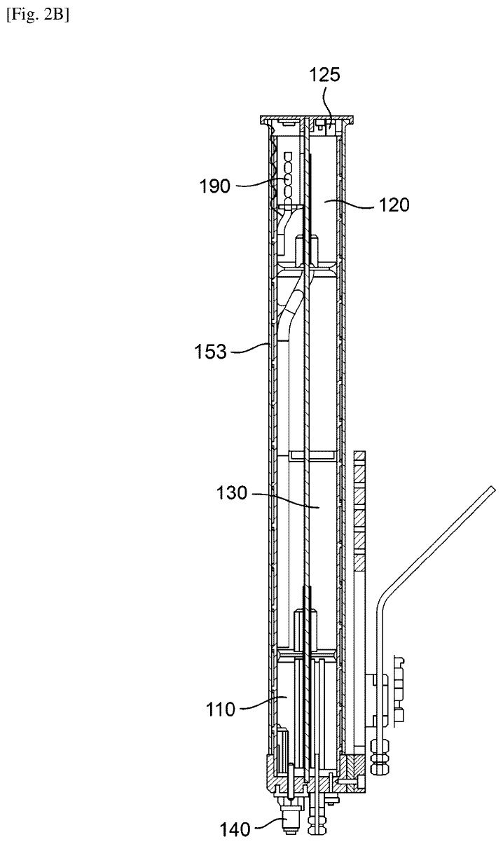

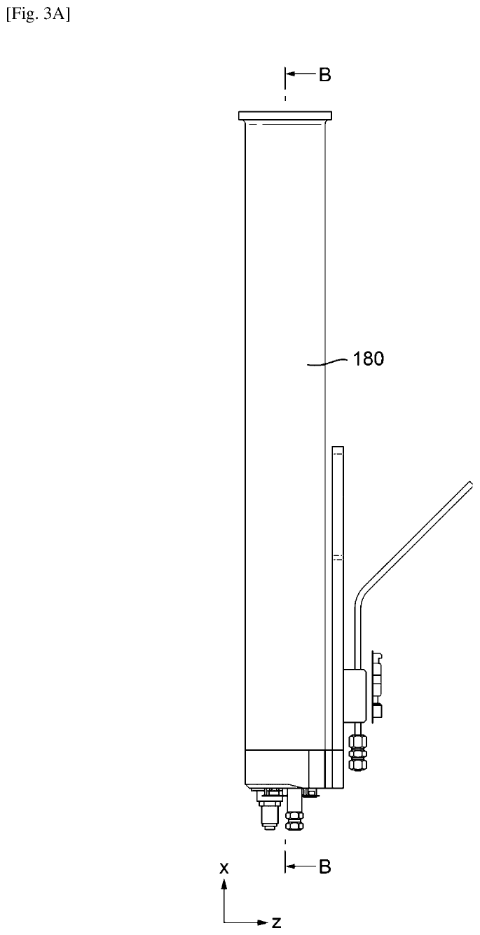

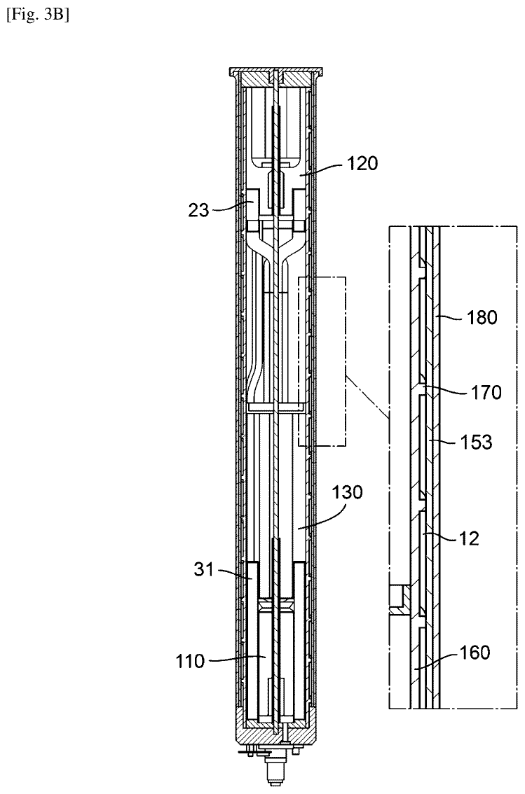

An ink delivery system is shown in FIGS. 2A, 2B, 3B and 3B. The ink delivery system of FIGS. 2 and 3 is suitable for being provided as the ink delivery system 100 in the printing system 200 of FIG. 1. A front view of the ink delivery system is shown in FIG. 2A, while FIG. 2B provides a cross-sectional view through section A-A of the ink delivery system of FIG. 2A. A side view of the ink delivery system, with a heater 180 provided around the outside of the outer casing, is shown in FIG. 3A, while FIG. 3B provides a cross-sectional view through section B-B of the ink delivery system of FIG. 3A. A magnified view of the ink flow channel 12 is also provided in FIG. 3B.

The ink delivery system as shown in FIGS. 2A, 2B, 3B and 3B comprises an outer casing 150 housing the sump tank 110, the header tank 120 and the ink flow channel 12. The outer casing comprises an outer wall 153. The outer wall 153 is configured to transmit heat to ink in the ink flow channel 12.

With this arrangement, the heater is desirably used to heat new ink supplied to the ink delivery system as well as to maintain the temperature of ink circulating through the ink delivery system. In this way, a separate heater dedicated solely to heating new ink being supplied to the ink delivery system, from the bulk ink delivery system, is not essential. Avoiding the need for a separate heater can reduce the size and complexity of the ink delivery system by reducing the number of components, thus enabling the system to be more compact. Furthermore, the reduction in number of components can reduce the cost and energy associated with manufacture of the system.

### Outer Casing

The ink delivery system comprises a heater configured to heat the outer wall of the outer casing. In the arrangements shown in FIG. 2B and FIG. 3B, the outer wall 153 comprises an inner surface defining a surface of the ink flow channel 12. The outer wall 153 also comprises an outer surface, on the exterior of the outer casing 150. Preferably, the ink flow channel 12 is configured such that ink in the ink flow channel 12 contacts the inner surface of the outer wall 153 of the outer casing 150.

In this configuration, the heater is configured to heat the outer surface of the outer wall. The outer wall 153 is configured to transfer heat from the heater 180 to ink in the ink flow channel 12. The outer wall 153 is preferably configured to conduct heat. The outer wall may comprise aluminium. In particular, the outer wall may be an aluminium wall. As shown in FIGS. 3A and 3B, the heater 180 may be provided in contact with the outer wall 153.

Alternatively, the outer wall may not comprise an inner surface defining a surface of the ink flow channel. Instead, the ink flow channel may be defined by an interior wall disposed within the outer casing. The ink delivery system may be configured such that heat from the outer wall is transferred to the interior wall. For example, the outer wall may be disposed in contact with the interior wall, or a conductive layer may be disposed between the outer wall and the interior wall to transfer heat from the outer wall to the interior wall.

### Ink Flow Path

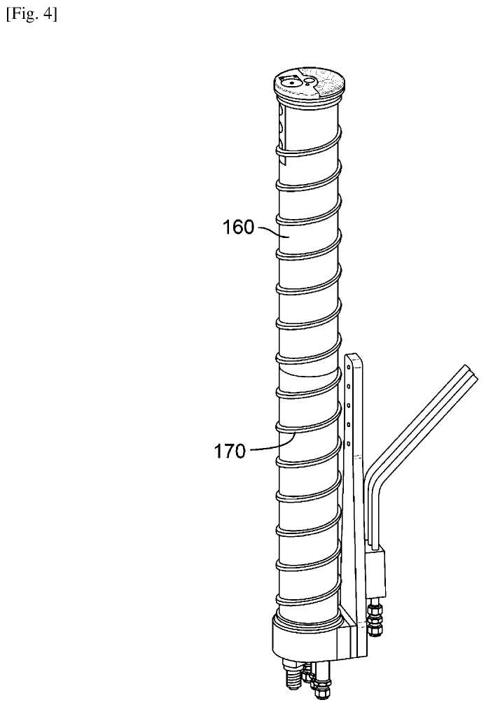

An interior of the ink delivery system according to FIGS. 2 and 3 is shown in FIG. 4. The outer wall 153 of the outer casing 150 of FIGS. 2 and 3 is not shown in FIG. 4, such that the interior of the ink delivery system, beneath the outer wall 153, is visible.

The ink delivery system as shown in FIG. 4 comprises an inner casing 160. The inner casing 160 is disposed within the outer casing (not shown in FIG. 4). The inner casing comprises an outer surface on the exterior of the inner casing. As shown in FIG. 4, a ridge 170 is provided on the outer surface of the inner casing. The ink delivery system is preferably configured such that, with the outer casing in place, the ridge 170 is disposed between the inner casing 160 and the outer casing 150. Alternatively, more than one ridge may be provided on the outer surface of the inner casing.

The ink flow channel may be defined by the inner surface of the outer casing 150, the outer surface of the inner casing, and the one or more ridges. In particular, as shown for example in FIG. 3B, the ink flow channel 12 may be defined by the inner surface of the outer wall 153 of the outer casing 150, the outer surface of the inner casing 160, and the one or more ridges 170.

The ink flow channel is configured to guide ink along an ink flow path between the sump outlet and the header inlet. The ink flow path preferably follows an indirect route from the sump outlet to the header inlet, for example, the path may follow a meandering route, or a helical route. With a meandering route, the ink flow path follows a winding course, preferably wherein the ink flow path goes around the circumference of the inside of the outer casing in a first direction, re-directs to a longitudinal direction of the outer casing, then re-directs to a second direction. Preferably, the first direction is a first circumferential direction of the outer casing and the second direction is an opposing circumferential direction of the outer casing. With a helical route, the helix defined by the ink flow path may have a constant diameter. Alternatively, the diameter of the helix may vary in a longitudinal direction of the outer casing. For example, the diameter at the sump outlet may be greater than the diameter at the header inlet or the diameter at the sump outlet may be smaller than the diameter at the header inlet. The ink flow path does not need to be exactly helical, for example the pitch of the helix may vary. The ink flow path may be a combination of a helical route and a meandering route.

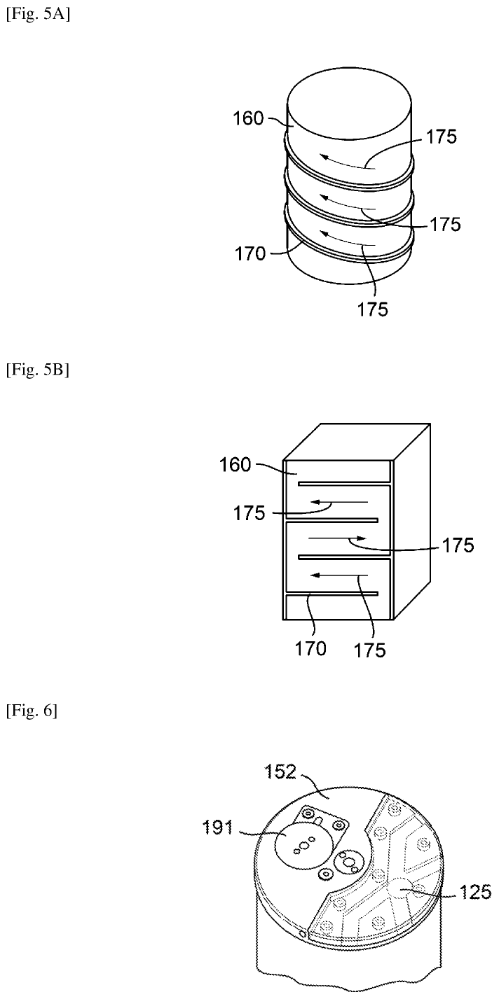

The shape of the one or more ridges preferably defines the route of the ink flow path between the inner casing and the outer casing from the sump outlet to the header inlet. A section of interior casing 160 with a ridge 170, similar to that of FIG. 4, defining a spiral flow path 175 is shown in FIG. 5A. In FIGS. 4 and 5A, the interior casing 160 is generally cylindrical, to correspond to a generally cylindrical outer casing. An alternative arrangement, with a generally cuboidal inner casing 160, to correspond to a generally cuboidal outer casing, is shown in FIG. 5B. A section of interior casing 160 with ridges 170 defining a meandering flow path 175 is shown in FIG. 5B. As shown in FIG. 5B, the flow path meanders along one dies of the cuboidal inner casing. Alternatively, the ridges could be provided such that the flow path meanders around a plurality of sides of the inner casing. Similarly, the meandering flow path is not limited to the cuboidal inner casing. A meandering flow path could be provided around a cylindrical inner casing, for example.

As shown in FIGS. 2B and 3B the sump tank 110 is preferably disposed at an opposite end of the outer casing 150 than the header tank 120 in a longitudinal direction X of the outer casing 150. The heater 180 is preferably disposed to contact the outer casing 150 in an area extending between the sump outlet and the header inlet in a longitudinal direction of the outer casing 150, as shown in FIG. 3B.

It is preferable that the ink flow path does not go directly from the sump outlet to the header inlet because a direct path would be shorter than an indirect path. With a longer, indirect, path, the ink may travel further through the ink flow channel. Consequently, the ink may remain in the ink flow channel for longer than it would if the ink path were shorter. As described above, the ink delivery system is preferably configured to heat the ink in the ink flow channel such that ink enters the header tank at the target ink temperature. If the ink moves too quickly through the ink flow channel then there is less time to impart heat to the ink in the ink flow channel, before that ink reaches the header tank. Thus, a longer path between the sump outlet and the header inlet may enable more effective heating of the ink in the ink flow channel.

Heating the ink in this manner avoids the requirement for a further, in-line, heater to directly heat ink provided by the bulk ink delivery system. Consequently, the number of components is reduced, thus reducing initial cost as well as maintenance time and cost.

### Heater

The heater is preferably configured to heat the ink in the ink flow channel such that the ink enters the header tank at a target ink temperature. The target ink temperature is preferably between 40° C. and 60° C., more preferably between 45° C. and 55° C., yet more preferably between 48° C. and 52° C.

The heater may be any heater suitable for heating the ink to the target ink temperature. The heater is preferably controllable and is also preferably able to change temperature quickly. In this way, the temperature of the heater can be adjusted to account for a sudden supply of new ink, for example when printing an image requiring a large amount of ink. The heater is preferably an electric heater. The heater may have a power of between 400 W and 1400 W. The heater preferably has a power of 600 W to 1200 W, more preferably 800 W to 1000 W. The heater power may be dependent on the size of the ink delivery system. In particular, the heater power may be dependent on the amount of ink the ink delivery system is configured to contain. For example, the greater the ink capacity of the ink delivery system, the higher power of heater may be provided. Preferably, the ink delivery system is configured to contain 5 to 15 litres of ink, more preferably 8 to 12 litres, yet more preferably 10 litres.

The heater preferably comprises a heat generating part configured to conform to the shape of the outer casing. The heater may comprise a heat mat. The heat may be disposed in contact with the outer casing to heat ink in the ink flow channel.

The heater may desirably be provided in contact with a large area of the outer casing and over the length of the ink flow path. In this way, the temperature of the ink in the ink delivery system does not fluctuate significantly and is readily maintained within an acceptable deviation of the target temperature.

### Compact Ink Delivery System

The sump tank 110 and the header tank 120 may be housed within the inner casing 160. Alternatively, as shown in FIGS. 2B and 3B, the inner casing may form the sump tank and the header tank. In other words, walls of the inner casing may define the sump tank and/or header tank. These walls of the inner casing may also define the ink flow channel. Similarly, the one or more ridges may be disposed on the outside of the sump tank and/or the header tank.

As shown in FIGS. 2A 3, 4, 6 and 7, the ink delivery system may comprise an end cap. In particular, the outer casing 150 may comprise at least one end cap. Preferably, the outer casing comprises a first end cap 151 at one end of the outer casing 150 and a second end cap 152 at an opposite end of the outer casing 150, in a longitudinal direction of the outer casing 150.

The first end cap 151 is preferably provided at a longitudinal end of the outer casing closest to the sump tank. The pump 140 may be attached to the outer casing 150 via the first end cap 151.

The ink delivery system may comprise one or more sensors. The one or more sensors may comprise an ink temperature sensor configured to measure the temperature of ink in the ink delivery system. The one or more sensors may comprise an ink pressure sensor configured to measure the pressure of ink flow through the ink delivery system. The one or more sensors may comprise an ink level sensor configured to measure the level of ink in one or more tanks of the ink delivery system, such as the sump tank or the header tank. The ink level sensor may, for example, be a float switch, optical level switch, ultrasonic sensor or any other suitable sensor for measuring a level of fluid in a tank. The ink level is desirably determined based on data from a pressure sensor. The pressure sensor may be disposed on the first end cap and configured to measure the pressure in the sump tank.

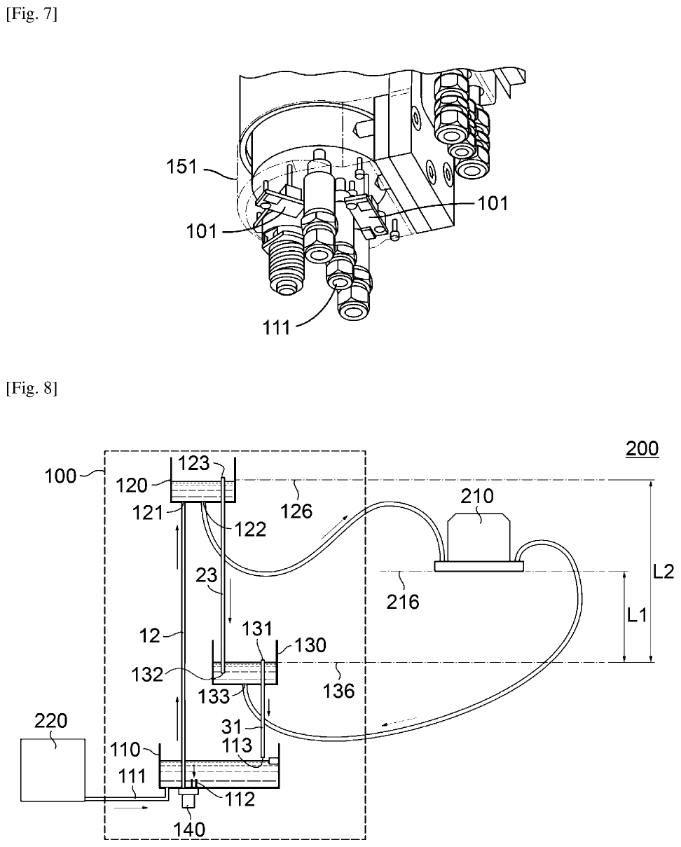

The sensors may comprise sensor electronics 101, such as sensor chips, for example as shown in FIG. 7. The sensor electronics 101 are preferably housed within the outer casing. The sensor electronics 101 are more preferable disposed in one of the end caps, such as first end cap 151. With this arrangement, the electronics are desirably provided at an end of the outer casing, without increasing the overall footprint of the ink delivery system. Thus, the ink delivery system may be compact.

The ink delivery system may comprise an ink filter housing configured to house an ink filter. The ink filter housing is preferably disposed within the outer casing. As shown, for example, in FIG. 2B and FIG. 6, the ink delivery system may comprise an ink filter 190 to filter ink circulating in the ink delivery system. The ink filter 190 is preferably disposed within the outer casing 150. The ink filter 190 is more preferably configured to filter ink flowing through the ink flow channel 12. The ink filter and/or ink filter housing being disposed within the outer casing desirably enables the ink delivery system to be compact with most components contained within the outer casing. With the compact design, the ink delivery system can be readily deployed to different printing systems even in limited space or areas of restricted accessibility for installation and maintenance.

In particular, as shown in FIG. 2B and FIG. 6, the ink filter housing may be accessible via an end cap, such as the second end cap 152. For example, as shown in FIG. 6, the second end cap 152 may comprise a filter port 191 configured to allow access to the ink filter housing. The filter port 191 is desirably configured such that the ink filter can be removed and replaced through the filter port 191. The filter port 191 may comprise a filter port cap configured to be opened to provide access to the ink filter. When closed, the filter port cap may prevent debris from the outside from entering the casing via the filter port 191. Thus, the ink filter may be readily replaced for case of maintenance.

With this configuration, components such as the ink filter and sensors, may be included within the outer casing such that the ink delivery system is compact and may be provided as a discrete unit for installation in a corresponding printing system.

### Consistent Ink Flow to Print Head

The ink delivery system is preferably configured such that the header tank 120 is higher than the sump tank 110 during use. Preferably, the header tank 120 is disposed directly above the sump tank 110 during use. Alternatively, the outer casing may be disposed at an angle to the vertical during use, such that the header tank is not directly above the sump tank, but the header tank is disposed higher than the sump tank.

Furthermore, the ink delivery system may comprises an opening 125 providing a vent from the header tank 120 to atmosphere. For example, as shown in FIG. 2B and FIG. 6, the opening 125 may be provided in a second end cap 152 of the outer casing 150, with the header tank 120 being disposed at an end of the outer casing 150 nearest to the second end cap 152, which is the upper end of the outer casing 150 during use.

With an arrangement such as this, gas may be vented from the system such that bubbles in the ink are reduced. Furthermore, gravity may aid the ink in travelling from the header tank 120 to the print head 210 and from the print head 210 to the sump tank 110. This has the benefit of reducing pressure fluctuations and improving print quality.

The ink delivery system preferably comprises a return tank 130, as shown in FIG. 2B, FIG. 3B and FIG. 8. The return tank 130 is configured to contain ink and having a print ink inlet 133 configured to receive ink from the print head 210, a return overflow inlet 132 configured to receive ink from the header tank 120. The return tank 130 also has a return overflow outlet 131 configured such that ink exceeding a predetermined threshold level in the return tank 130 flows to the sump tank 110. In particular, as shown in FIG. 8, the ink may flow from the return tank 130 out of the return overflow outlet 131, through a return overflow channel 31 to the sump inlet 113 of the sump tank 110. In this configuration, as shown in FIG. 8, the header tank 120 comprises a header overflow outlet 123 configured such that ink exceeding a predetermined threshold level in the header tank 120 flows to the return tank 130. In particular, the ink flows from the header overflow outlet 123 through a header overflow channel 23 to a return overflow inlet 132. The ink delivery system is configured such that the return tank 130 is lower than the header tank and higher than the sump during use. This arrangement promotes a constant flow of ink from the header tank, through the print head and to the return tank, aided by gravity.

The pump 140 is configured to supply ink from the sump tank 110 to the header tank 120. However, with the arrangement as shown in FIG. 8, ink can flow from the header tank 120 to the print head 210 without actively being pumped from the header tank 120. Thus, the ink flows to the print head 210 due to gravity. Consequently, the ink has a more constant flow pressure at the print head than in configurations which require a pump to actively force ink to the print head. As shown in FIG. 8, the print head 210 may include a print face at a print face level 216. The print face is a lower surface of the print head, from which ink is deposited during use.

The printing system 200 is preferably configured such that the print head 210 is between the return tank 130 and the header tank 120 in a vertical direction, as shown in FIG. 8. The vertical distance between the return tank 130 and the print head 210 is preferably 50% to 70% of the vertical distance between the return tank 130 and the header tank 120, more preferably 55% to 65%, yet more preferably 60%. In particular, a vertical distance L1 between an ink level 136 in the return tank 130 and the print face level 216 of the print head 210 is preferably 50% to 70% of a vertical distance L2 between an ink level 136 in the return tank 130 and an ink level 126 in the header tank 120, more preferably 55% to 65%, yet more preferably 60%. This arrangement may aid in maintaining a desirable pressure at the print head.

Alternatively, or additionally, pressure at the print head may also be controlled by altering the pressure drop upstream or downstream of the print head. This may be achieved, for example, by restricting ink flow upstream of the print head to reduce pressure at the print head and/or by restricting ink flow downstream of the print head to increase pressure at the print head.

The ink delivery system may be configured such to actively change the vertical distance between the return tank 130 and the header tank 120. For example, the return tank 130 may be actuated to move in a longitudinal direction of the outer casing. Additionally, or alternatively, the ink delivery system may be actuated to tilt to change the vertical distance between the header tank and the return tank. Additionally, or alternatively, the printing system may be configured such that a vertical position of the print head may be changed relative to the ink delivery system. In particular, the ink delivery system may be actuated to change vertical position relative to the print head.

As described above with reference to FIG. 8, the header overflow outlet 123 may be configured to ensure the ink in the header tank 120 does not exceed a predetermined threshold level. Similarly, the return overflow outlet 131 may be configured to ensure the ink in the return tank 130 does not exceed a predetermined threshold level. For example, the outlet may be disposed at a predetermined distance from the bottom of the corresponding tank. In this way, the distance between the bottom of the tank and the outlet may correspond to the depth of ink in that tank at the predetermined threshold level. If the ink level in the tank reaches the predetermined threshold level, it will be directed through the overflow to the tank below. This is therefore one way to maintain the ink at the desired level in the tanks.

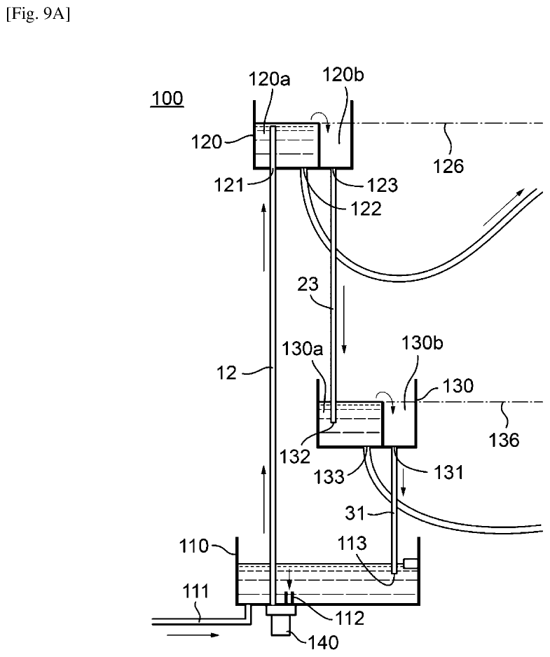

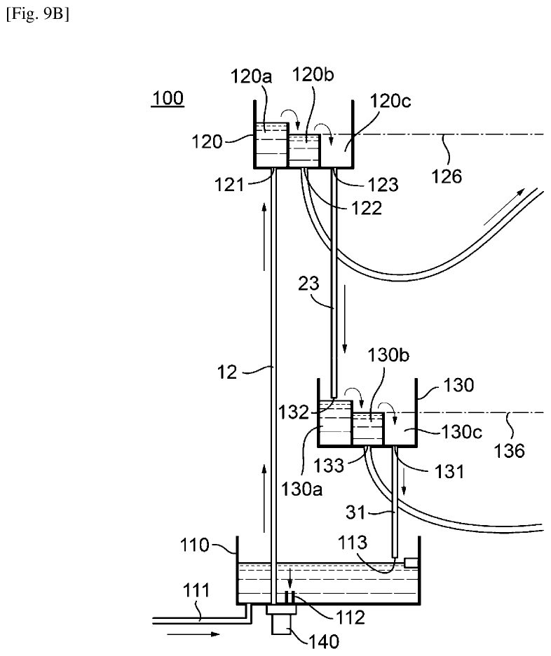

Alternatively, or additionally, the ink level may be maintained by providing the header tank 120 and/or the return tank 130 with a plurality of chambers, for example as shown in FIGS. 9A and 9B.

As shown in FIG. 9A, the header tank 120 may comprise a first chamber 120a and a second chamber 120b. In the arrangement of FIG. 9A, the header inlet 121 may be disposed to enable ink to enter the first chamber 120a. During use, ink from the sump tank 110 may therefore be pumped to the first chamber 120a of the header tank 120. The header outlet 122 may be disposed to provide ink from the first chamber 120a to the print head. The first chamber 120a of the header tank 120 is desirably configured such that the ink does not exceed an ink level 126 in the first chamber 120a. The first chamber 120a of the header tank 120 may be configured such that ink will overflow to the second chamber 120b of the header tank 120 such that ink in the first chamber 120a does not exceed the ink level 126. The second chamber 120b of the header tank 120 in the arrangement of FIG. 9A is configured to drain to the return tank 130 via the header overflow channel 23.

As shown in FIG. 9A, the return tank 130 may comprise a first chamber 130a and a second chamber 130b. In the arrangement of FIG. 9A, the return inlet 132 may be disposed to enable ink to enter the first chamber 130a. During use, ink overflowed from the header tank 120 may therefore be drained to the first chamber 130a of the return tank 130. The print ink inlet 133 may be disposed to provide ink from the print head to the first chamber 130a of the return tank 130. The first chamber 130a of the return tank 130 is desirably configured such that the ink does not exceed an ink level 136 in the first chamber 130a. The first chamber 130a of the return tank 130 may be configured such that ink will overflow to the second chamber 130b of the return tank 130 such that ink in the first chamber 130a does not exceed the ink level 136. The second chamber 130b of the return tank 130 in the arrangement of FIG. 9A is configured to drain to the sump tank 110 via the return overflow channel 31.

As shown in FIG. 9B, the header tank 120 may comprise a first chamber 120a, a second chamber 120b and a third chamber 120c. Alternatively, or additionally, the return tank 130 may also comprise a first chamber 130a, a second chamber 130b and a third chamber 130c. In the arrangement of FIG. 9B, the header inlet 121 may be disposed to enable ink to enter the first chamber 120a. During use, ink from the sump tank 110 may therefore be pumped to the first chamber 120a of the header tank 120. The first chamber 120a is configured such that over a certain level, ink overflows to the second chamber 120b. The header outlet 122 may be disposed to provide ink from the second chamber 120b to the print head. The second chamber 120b of the header tank 120 may be configured such that ink will overflow to the third chamber 120c of the header tank 120 such that ink in the second chamber 120b does not exceed the ink level 126. The third chamber 120c of the header tank 120 in the arrangement of FIG. 9B is configured to drain to the return tank 130 via the header overflow channel 23.

In the arrangement of FIG. 9B, the return inlet 132 may be disposed to enable ink to enter the first chamber 130a. During use, ink overflowed from the header tank 120 may therefore be drained to the first chamber 130a of the return tank 130. The first chamber 130a is configured such that over a certain level, ink overflows to the second chamber 130b. The print ink inlet 133 may be disposed to provide ink from the print head to the second chamber 130b of the return tank 130. The second chamber 130b of the return tank 130 may be configured such that ink will overflow to the third chamber 130c of the return tank 130 such that ink in the second chamber 130b does not exceed the ink level 136. The third chamber 130c of the return tank 130 in the arrangement of FIG. 9B is configured to drain to the sump tank 110 via the return overflow channel 31.

In arrangements having a plurality of chambers in the header tank. The predetermined threshold level, or ink level 126, is desirably set based on the ink level in the chamber in which the header outlet 122 is disposed. Similarly, in the return tank, The ink level 136, is desirably set based on the ink level in the chamber in which the print ink inlet 133 is disposed. In this way, the ink levels in the chambers which most directly provide ink to or receive ink from the print head are used to control the pressure at the print head.

This arrangement may desirably reduce the risk of pump pressure fluctuations, which can adversely affect pressure at the print face. This arrangement may also desirably reduce the risk of bubbles transferring from the pump to the print head. In particular, any bubbles in the ink pumped to the header tank will tend to surface in the first chamber of the header tank. Even if these bubbles are transferred (together with ink overflowing from the first chamber of the header tank) to the second chamber, the bubbles tend to remain at the surface (at the ink level 126) and are very unlikely to flow down to the header outlet, which is desirably disposed at or near the bottom of the header tank.

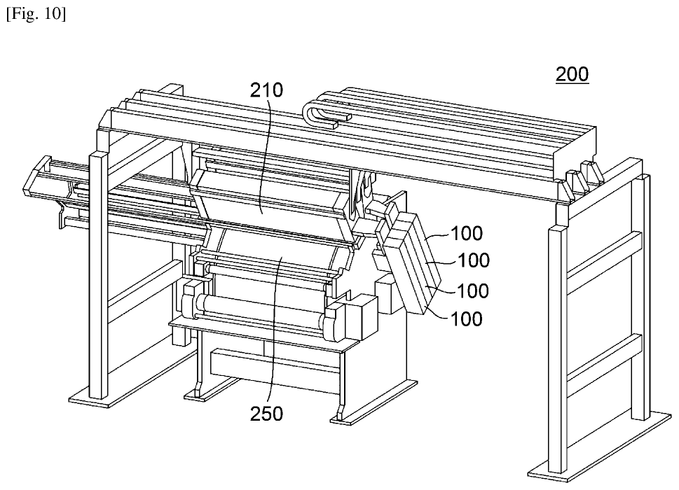

An example of a printing system 200 is shown in FIG. 10. The printing system 200 comprises, an ink delivery system 100, a print head 210 and a recording medium 250. As shown in FIG. 10, the printing system 200 may comprise a plurality of an ink delivery systems 100. The ink delivery systems are in accordance with the ink delivery system as described above with reference to FIGS. 1 to 9. The ink delivery system 100 is configured to supply ink to the print head 210. The print head 210 is configured to deposit ink onto the recording medium 250. As described above, the ink delivery systems may be configured to move such that the vertical position of the return tank and/or the header tank changes relative to the vertical position of the print head. For example, the printing system may be configured such that the ink delivery system is movable in a vertical direction or in a longitudinal direction of the ink delivery system. Alternatively, or additionally, the printing system may be configured such that the ink delivery system is tiltable such that angle between the longitudinal direction of the ink delivery system and the vertical may be changed.

### Control System

The ink delivery system may comprise a control system configured to set a target heater temperature of the heater. The target heater temperature may be set based on information of ink supply from the bulk ink delivery system to the sump tank. The target heater temperature may alternatively or additionally be set based on the target ink temperature. The target heater temperature may alternatively or additionally be set based on the predetermined maximum ink temperature. The target heater temperature may, for example, be between 5° C. and 20° C. higher than the target ink temperature, preferably 15° C. higher, more preferably 10° C. higher.

The heater is therefore desirably used to maintain the ink at the target temperature even when colder, new ink is supplied from the bulk ink delivery system. It is therefore not necessary to employ a separate, in-line, heater solely to heat the new cold ink to the target temperature. In this way, the risk of unnecessary overheating is reduced. It is desirable to avoid overheating the ink as this can damage the ink and also wastes energy. Furthermore, to heat the new ink from ambient to target temperature using a separate, dedicated in-line heater can take a large amount of power. Thus, the power requirements of the system may be reduced by the heater being provided around the outer casing along the ink flow path.

The information of ink supply from the bulk ink delivery system to the sump tank may include information that ink is being supplied to the sump tank. The control system may be configured, in response to receiving the information that ink is being supplied to the sump tank, to increase the target heater temperature. Alternatively, or additionally, the control system may alternatively be configured to increase power to the heater in in response to receiving the information that ink is being supplied to the sump tank. The result being that the more heat is provided by the heater as the colder new ink is introduced to the ink delivery system. Consequently, the target ink temperature may be maintained in the ink in the header tank.

The control system may be configured, in response to receiving the information that ink has ceased being supplied to the sump tank, to decrease the target heater temperature. Alternatively, or additionally, the control system may be configured to reduce power to the heater in in response to receiving the information that ink has ceased being supplied to the sump tank. Optionally, the power to the heater may be reduced such that no power is supplied to the heater when ink has ceased being supplied to the sump.

Information that ink is being supplied to the sump tank may include an amount of ink being supplied to the sump tank. Additionally, information that ink is being supplied to the sump tank may include an amount of time ink has been supplied to the sump tank without interruption. Preferably information that ink is being supplied to the sump tank includes a rate of ink being supplied to the sump tank.

Information of ink supply from the bulk ink delivery system to the sump tank may be determined based on monitoring flow of ink through the incoming ink inlet. Alternatively, or additionally, information of ink supply from the bulk ink delivery system to the sump tank may be determined based on the bulk ink delivery system being commanded to supply ink.

The amount of power to the heater and/or the target temperature of the heater may be set based on a flow rate of ink into the sump tank. In other words, the control system may be configured to set a target heater temperature or a heater power based on the rate of ink being supplied to the sump tank. The target heater temperature or heater power being set to maintain the target ink temperature in the header tank.

One or more temperature sensors may be provided in the header tank to monitor the temperature of ink in the header tank. The target heater temperature or heater power may be adjusted based on the temperature of ink in the header tank. For example, the target heater temperature may be increased if the temperature of ink in the header tank falls, or the target heater temperature may be decreased in the temperature of ink in the header tank is within a predetermined margin of the predetermined maximum ink temperature.

Alternatively, or additionally, one or more temperature sensors may be provided in the sump tank to monitor the temperature of ink in the sump tank. The data of ink supplied to the sump tank may be based on the temperature of ink in the sump tank. Due to the new ink being stored at ambient room temperature in the bulk ink delivery system, the temperature of ink in the sump tank will drop when new in is supplied to the sump tank. The control system may be configured to increase the target heater temperature in response to a drop in temperature of ink in the sump tank.

The information of ink supply from the bulk ink delivery system to the sump tank may include a predicted time until the next ink supply from the bulk ink delivery system to the sump based on print data. The control system may be configured to set the target temperature of the heater, or amount of power provided to the heater, based on the predicted time until the next ink supply. In particular, the control system may be configured to increase the target temperature of the heater in response to the predicted time until the next ink supply being less than or equal to a predetermined time threshold. In this way the ink in the ink delivery system does not fall too low due to the supply of colder new ink from the bulk ink delivery system, because the heater is controlled to start heating in anticipation of new ink being supplied to the ink delivery system.

### Manufacturing Method

The outer casing and/or the one or more end caps preferably comprises metal, for example aluminium. In particular, the outer casing preferably comprises a metal tube. The outer wall of the outer casing is preferably a metal wall, more preferably an aluminium wall.

A method of manufacturing the ink delivery system of any of FIGS. 1-9 may comprise a step of additive manufacturing. Preferably, the additive manufacturing method is selective laser sintering. Preferably, the material used in the additive manufacture is polyamide. Components which are formed by additive manufacturing may be chemically smoothed. This may provide the benefit of sealing the material and preventing plastic particles from contaminating the ink.

In particular, the one or more ridges may be formed using additive manufacturing. Optionally, all or part of the inner casing may be formed using additive manufacturing. This method of manufacture enables the one or more ridges to be more easily formed in the desired shape than other methods of manufacture.

Furthermore, by using additive manufacture, it may be easier to provide the first and second end caps, as described above with reference to FIGS. 6 and 7. For example, a filter housing which is accessible via an end cap of the ink delivery system may be readily formed using additive manufacturing. Similarly, an opening may be readily provided in an end cap such that the header tank is vented to the atmosphere. Consequently, this manufacturing method means a more compact ink delivery system can be provided without the cost of manufacture being increased compared to traditional methods.

The additive manufacture process is cost effective and makes efficient use of materials. Although additive manufacture is preferred, due to the cost-effectiveness and adaptability of this method for example to different shapes of ridge, alternative methods of manufacture may be used provided that a suitable ink flow path can be achieved. For example, a subtractive manufacture process such as milling may be used.

### CONCLUSION

Aspects of the present disclosure have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention, as defined by the claims.

The present application is based on and claims priority of United Kingdom Priority Application No. GB2204762.5 filed on Apr. 1, 2022, the entire contents of which are hereby incorporated herein by reference.

1. An ink delivery system for supplying ink to a print head, comprising:
a sump tank configured to contain ink and having an incoming ink inlet configured to receive ink from a bulk ink delivery system, a sump inlet configured to receive ink from a print head, and a sump outlet configured to supply ink to a header tank;
the header tank configured to contain ink and having a header inlet configured to receive ink from the sump tank and a header outlet configured to supply ink to the print head;
an ink flow channel between the sump tank and the header tank;
a pump configured to pump ink from the sump tank, through the ink flow channel, to the header tank;
an outer casing housing the sump tank, the header tank and the ink flow channel; the outer casing comprising an outer wall configured to transmit heat to ink in the ink flow channel; and
a heater configured to heat the outer wall of the outer casing.

2. The ink delivery system according to claim 1, wherein
the outer wall comprises an inner surface defining a surface of the ink flow channel, and an outer surface, on the exterior of the outer casing; wherein the heater is configured to heat the outer surface of the outer wall.

3. The ink delivery system according to claim 2, wherein
the ink flow channel is configured such that ink in the ink flow channel contacts the inner surface of the outer wall of the outer casing.

4. The ink delivery system according to claim 2, wherein
the ink flow channel is configured to guide ink along an ink flow path between the sump outlet and the header inlet; wherein the ink flow path follows an indirect route from the sump outlet to the header inlet.

5. The ink delivery system according to claim 4, wherein the ink flow path is a helix or a meander.

6. The ink delivery system according to claim 2, further comprising:
an inner casing disposed within the outer casing, and comprising an outer surface on an exterior of the inner casing; and
one or more ridges between the inner casing and the outer casing; wherein the ink flow channel is defined by the inner surface of the outer casing, the outer surface of the inner casing, and the one or more ridges.

7. The ink delivery system of claim 6, wherein
the sump tank and the header tank are housed within the inner casing.

8. The ink delivery system of claim 6, wherein
the inner casing forms the sump tank and the header tank.

9. The ink delivery system of claim 6, wherein
the shape of the one or more ridges defines the route of the ink flow path between the inner casing and the outer casing from the sump outlet to the header inlet.

10. The ink delivery system of claim 1, wherein the heater is configured to heat the ink in the ink flow channel such that the ink enters the header tank at a target ink temperature between 45° C. and 55° C.

11. The ink delivery system of claim 1, wherein
the heater is disposed to contact the outer casing in an area extending between the sump outlet and the header inlet in a longitudinal direction of the outer casing.

12. The ink delivery system of claim 1, wherein
the heater is an electric heater.

13. The ink delivery system of claim 1, wherein
the sump tank is disposed at an opposite end of the outer casing than the header tank in a longitudinal direction of the outer casing.

14. The ink delivery system of claim 1, wherein
the outer casing has a cylindrical shape, and the ink delivery system is configured such that the header tank is higher than the sump during use.

15. The ink delivery system of claim 14, further comprising:
a return tank configured to contain ink and having a return inlet configured to receive ink from the print head, a return overflow inlet configured to receive ink from the header tank and a return overflow outlet configured such that ink exceeding a predetermined threshold level in the return tank flows to the sump tank;
wherein the header tank comprises a header overflow outlet configured such that ink exceeding a predetermined threshold level in the header tank flows to the return tank, and
wherein the ink delivery system is configured such that the return tank is lower than the header tank and higher than the sump during use.

16. The ink delivery system of claim 1, wherein
the ink delivery system comprises an opening providing a vent from the header tank to atmosphere.

17. The ink delivery system of claim 1, further comprising:
an ink filter disposed within the outer casing and configured to filter ink flowing through the ink flow channel.

18. The ink delivery system of claim 1, further comprising:
a control system configured to set a target temperature of the heater based on information of ink supply from the bulk ink delivery system to the sump.

19. A printing system comprising:
an ink delivery system according to claim 1;
a bulk ink delivery system configured to supply ink to the sump tank via the incoming ink inlet; and
a print head, wherein the ink delivery system is configured to supply ink to the print head.

20. A method of manufacturing the ink delivery system of claim 1, comprising:
a step of additive manufacturing.
